(19) United States
(12) Patent Application Publication
(10) Pub. No.: US 2015/0142808 A1
(43) Pub. Date: May 21, 2015

(54) SYSTEM AND METHOD FOR EFFICIENTLY DETERMINING K IN DATA CLUSTERING

(71) Applicant: Futurewei Technologies Inc., Plano, TX (US)

(72) Inventors: Da Qi Ren, Saratoga, CA (US); Da Zheng, Beijing (CN); Zhulin Wei, Santa Clara, CA (US)

(21) Appl. No.: 14/543,819

(22) Filed: Nov. 17, 2014

Related U.S. Application Data
(60) Provisional application No. 61/905,055, filed on Nov. 15, 2013.

(51) Int. Cl. G06F 17/18; G06F 17/30

(52) U.S. Cl. CPC G06F 17/18; G06F 17/30598
USPC 707/737

(57) ABSTRACT

A system is configured to perform an iterative method for efficiently determine a value k in k-means data clustering. The method includes performing a k-means algorithm for each number k of a set of numbers in a range of 1 to Kₘₐₓ for a space of data to determine a plurality of cluster centers, each k-means algorithm performed in parallel by one of a plurality of nodes in a parallel computing platform. The method also includes generating a distortion curve from the results of performing the k-means algorithms. The method further includes identifying, after one or more iterations of the performing and generating steps, an updated number k of clusters of the space of the data, based on the distortion curve.

### CROSS-REFERENCE TO RELATED APPLICATION(S) AND CLAIM OF PRIORITY

The present application is related to U.S. Provisional Patent Application No. 61/905,055, filed Nov. 15, 2013, entitled “EFFICIENT METHOD TO DETERMINE K”. Provisional Patent Application No. 61/905,055 is assigned to the assignee of the present application and is hereby incorporated by reference into the present application as if fully set forth herein. The present application hereby claims priority under 35 U.S.C. §119(e) to U.S. Provisional Patent Application No. 61/905,055.

### TECHNICAL FIELD

The present disclosure relates generally to data clustering, and more particularly, to a system and method for efficiently determining k in data clustering.

### BACKGROUND

As telecommunications markets continue to develop, data mining (DM) techniques are becoming popular to analyze the users' communication features. Careful analysis can be performed to provide personalized service and prevent the loss of customers. One major DM technique on telecommunication networks includes using data exploration technology to extract the data, create a predictive model using a decision tree, test the model, and verify its effectiveness and stability. A k-means method is used for customer clustering, to segment the customers as clusters based on billing, loyalty and payment behavior, so that reference can be made from the clustering results to create each model by the decision tree.

Determining the number of clusters k in a data set with limited prior knowledge of the appropriate value is a frequent problem and a distinct issue from the process of actually solving data clustering.

### SUMMARY

According to one embodiment, there is provided an iterative method for determining a k value in k-means clustering. The method includes performing a k-means algorithm for each number k of a set of numbers in a range of 1 to Kₘₐₓ for a space of data to determine a plurality of cluster centers, each k-means algorithm performed in parallel by one of a plurality of nodes in a parallel computing platform. The method also includes generating a distortion curve from the results of performing the k-means algorithms. The method further includes identifying, after one or more iterations of the performing and generating steps, an updated number k of clusters of the space of the data, based on the distortion curve

According to another embodiment, there is provided a method that includes performing a k-means algorithm for each number k of a set of numbers in a range of 1 to Kₘₐₓ for a space of data to determine a plurality of cluster centers, each k-means algorithm performed in parallel on one of a plurality of nodes; generating a distortion curve from the results of performing the k-means algorithms; and identifying, after one or more iterations of the performing and generating steps, a number of clusters of the space of the data based on the distortion curve.

According to yet another embodiment, there is provided a system that includes a plurality of first nodes and a second node. The plurality of first nodes are configured to perform a plurality of k-means algorithms in parallel to determine a plurality of cluster centers, the plurality of k-means algorithms comprising a set of algorithms corresponding to each number k of a set of numbers in a range of 1 to Kₘₐₓ for a space of data, each first node configured to perform one of the k-means algorithms. The second node is configured to generate a distortion curve from the results of the first nodes performing the k-means algorithms; and identify, after one or more iterations of the performing and generating steps, a number of clusters of the space of the data based on the distortion curve.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIGS. 1A through 1D illustrate data sets with five synthetic clusters and different values of k;

FIG. 2 illustrates an “elbow” method for determining a value k;

FIG. 3 illustrates a parallel algorithm to implement k search and k-means clustering according to this disclosure;

FIGS. 4A and 4B illustrate an example process for merging centroids according to this disclosure;

FIGS. 5A and 5B illustrate an example process for removing centroids according to this disclosure;

FIGS. 6A and 6B illustrate speed increase performance results for two-dimensional objects using initial centroids optimization and parallel algorithm according to this disclosure;

FIGS. 7A and 7B illustrate speed increase performance results for ten-dimensional objects using initial centroids optimization and parallel algorithm according to this disclosure; and

FIG. 8 illustrates an example of a computing device for performing at least a portion of a method for determining a value k, according to this disclosure.

### DETAILED DESCRIPTION

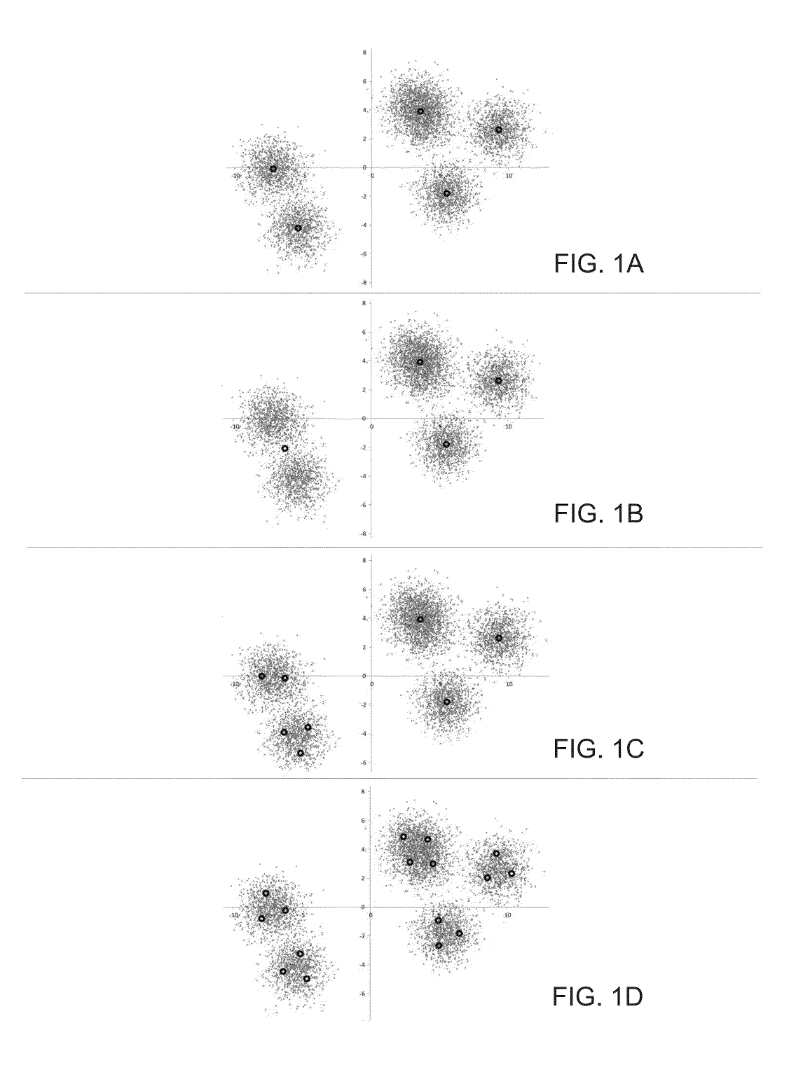

FIGS. 1A through 8 discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

The following documents are hereby incorporated into the present disclosure as if fully set forth herein:

(i) Robert L. Thorndike, “Who Belong in the Family,” Psychometrika 18 (4): 267276. doi:10.1007/BF02289263 (hereinafter “REF1”); (ii) J. T. Tou and R. C. Gonzalez, “Pattern Recognition Principles,” Addison-Wesley, Reading, Mass., 1974 (hereinafter “REF2”); (iii) Anand Rajaraman, Jure Leskovec and Jeffrey D. Ullma, “Mining of Massive Datasets,” Cambridge University Press, ISBN 1107015359, 2012 (hereinafter “REF3”); (iv) Dan Pelleg and Andrew W. Moore, “X-means: Extending K-means with Efficient Estimation of the Number of Clusters,” ICML ’00 Proceedings of the Seventeenth International Conference on Machine Learning, ISBN:1-55860-707-2, pp. 727-734, Morgan Kaufmann Publishers Inc., San Francisco, Calif., USA, 2000 (hereinafter “REF4”); (v) Catherine A. Sugar and Gareth M. James, “Finding the number of clusters in a data set: An information theoretic approach,” Journal of the American Statistical Association 98, pp. 750763 (hereinafter “REF5”); (vi) Yucheng Low, Joseph Gonzalez, Aapo Kyrola, Danny Bickson, Carlos Guestrin, and Joseph M. Hellerstein, “GraphLab: A New Parallel Framework for Machine Learning,” Conference on Uncertainty in Artificial Intelligence (UAI), 2010 (hereinafter “REF6”); (vii) X. Li and Z. Fang, “Parallel clustering algorithms,” Parallel Computing, vol. 11, issue 3, 1989, pp. 275-290 (hereinafter “REF7”); (viii) I. Dhillon and D. Modha, “A data-clustering algorithm on distributed memory multiprocessors,” Proceedings of ACM SIGKDD Workshop on Large-Scale Parallel KDD Systems, 1999, pp. 47-56 (hereinafter “REF8”); and (ix) S. Kantabutra and A. Couch, “Parallel k-means clustering algorithm on NOWs,” NECTEC Technical Journal, vol. 1, no. 6, 2000, pp. 243-248 (hereinafter “REF9”).

K-means is an important data clustering technique to group together objects that have similar characteristics in order to facilitate their further processing. One challenge with k-means is that it is computationally difficult (NP-hard). It has been used in many engineering applications such as identification of complex network community structures, medical imaging, and biometrics. K-means algorithms require the number of clusters k to be pre-specified. For example, FIGS. 1A through 1D illustrate data sets having a plurality of data points arranged into clusters. The data points could represent any type of similar data objects. For example, each data point could represent an online consumer browsing a retail website (e.g., AMAZON.COM) from a personal computing device, such as a desktop, tablet, or smart phone. As another example, each data point could represent a user logging into a social media website (e.g., LINKED-IN). The locations of the data points in FIGS. 1A through 1D could correlate to geographic locations of the users. That is, the users could be geographically clustered in urban areas, with a few users scattered in more rural locations.

Looking at the data in FIGS. 1A through 1D, it appears that the data points are arranged in five synthetic clusters of data. Thus, the real value of k (i.e., the number of cluster centers, or “centroids”) is 5, as shown in FIG. 1A. However, in most applications using such data sets, there is no such prior knowledge of the value of k available to the application. Thus, determining the number k becomes a significant problem in these applications. A value of k can be determined. For example, the determined k value is different in each figure: in FIG. 1B, k=4; in FIG. 1C, k=8; and in FIG. 1D, k=16.

There are several techniques to determine the value of k, but the optimal choice of k will maximally compress the data inside a single cluster, and accurately assign each observation into its own cluster. One popular approach is called the “elbow” method. In the elbow method, the percentage of variance explained by the clusters is graphed against the number of clusters. If the first clusters will add much information, but at some point the marginal gain will decrease, giving an angle in the graph, the number of clusters is chosen at the determined point called the “elbow criterion.” This approach is computationally expensive because it requests several rounds of computing to determine the variance of different numbers of clusters.

Reported studies on k-means clustering and its applications usually do not contain any explanation or justification for selecting particular values for k. Some existing methodologies have been investigated. In REF4, information criterion approaches are introduced as a method for determining the number of clusters, such as the Akaike information criterion (AIC) and the Bayesian information criterion (BIC). An Information Theoretic Approach in REF5 has been applied to choosing k called the “jump” method, which determines the number of clusters that maximizes efficiency while minimizing error by information theoretic standards. To obtain acceptable computational speed on huge datasets, most researchers turn to parallelizing schemes. REF7 proposes a parallel algorithm on a single instruction multiple data (SIMD) architecture. REF8 proposes a distributed k-means that runs on a multiprocessor environment. REF9 proposes a master-slave single program multiple data (SPMD) approach on a network of workstations to parallelize the k-means algorithm.

To address these limitations, embodiments of this disclosure provide a parallel approach to accelerate the determination of the number of clusters k in n observations. Two methods to select the initial centroids are described that can reduce the number of iterations in the computation of k-means clustering, namely 1) carrying centroids forward method, and 2) minimum impact method. These methods accelerate the computing of k-means, and the determination of k at the same time. In contrast to other techniques, the disclosed embodiments feature a parallel k-means algorithm that combines k value determination together with clustering computation, and the new optimization approach on initial centroid selections.

Parallel Computing Model

A. K-Means Method

The K-means method disclosed herein minimizes the sum of squared distances between all points and the cluster center. One of the most widely used methods to classify the structure of data is the algorithm introduced in REF2. It is an unsupervised clustering technique. The general procedure includes the following steps:

1) Given a space of data, assume the number of clusters is k;

2) Let C₁⁽⁰⁾, C₂⁽⁰⁾, . . . , Cₖ⁽⁰⁾ represent the total k initial cluster centers (centroids). Likewise, at the m-th iterative clustering operation step, the cluster centroids are represented as C₁^{(m)}, C₂^{(m)}, . . . , Cₖ^{(m)}.

3) Let Sᵢ and Sⱼ represent the cluster i and j, i,j ∈ 1, 2, . . . , k, i≠j. At the m-th iterative clustering operation step, let Sᵢ^{(m)} and Sⱼ^{(m)} denote the set of objectives whose cluster centers are Cᵢ^{(m)} and Cⱼ^{(m)}, distribute each objective e among the k clusters using Equation (1) below:

e ∈ Sᵢ^{(m)} if ∥e−Cᵢ^{(m)}∥<∥e−Cⱼ^{(m)}∥ (1)

4) For i ∈ 1, 2, . . . , k, compute the new cluster centers Cᵢ^{(m+1)}, such that the sum of the squared distances from all objectives e in Sᵢ^{(m)}, represented as Sᵢ^{(m)}(e), to the new cluster center is minimized. The new cluster center is given by:

$${C}_{i}^{( m + 1 )} = \frac{1}{{N}_{i}} {\sum }_{e ∈ {S}_{i}^{( m )}}^{ } {S}_{i}^{( m )} ( e ) , i = 1 , 2 … , k \qquad ( 2 )$$

where Nᵢ is the number of objectives in Sᵢ^{(m)}.

5) For i=1, 2, . . . , k, repeat step 2 and step 3 until Cᵢ^{(m+1)}=Cᵢ^{(m)}. The algorithm is then converged and the procedure is terminated.

B. Determination of k Value

In analysis of customers on telecommunication networks, the range of k can be determined based on the information provided by the operators, e.g., from 1 to a maximum value Kₘₐₓ. In this range, the real value of k should be reasonably large in order to reflect the specific characteristics of the data sets; however, it should not be too close to the number of objects, which would make the clustering operation less meaningful.

To find a proper value of k, a method based on the elbow method can be used. The strategy of the method is to generate a distortion curve for the input data by running a standard k-means for all values of k between 1 and Kₘₐₓ, and compute the distortion of the resulting clustering. A specific range will be found inside in which there is very little decrease in the average diameter. In detail, for the range of k in [1; Kₘₐₓ], the method begins with running the k-means algorithm for k=1,2, . . . , log₂Kₘₐₓ, until the specific range is found, and it is concluded that the k value lies within the range.

If the range is in [Kₘₐₓ/2; Kₘₐₓ], another log₂ Kₘₐₓ iteration of computing is performed. The maximum number of tests that may need to be performed is 2 log₂ Kₘₐₓ+1.

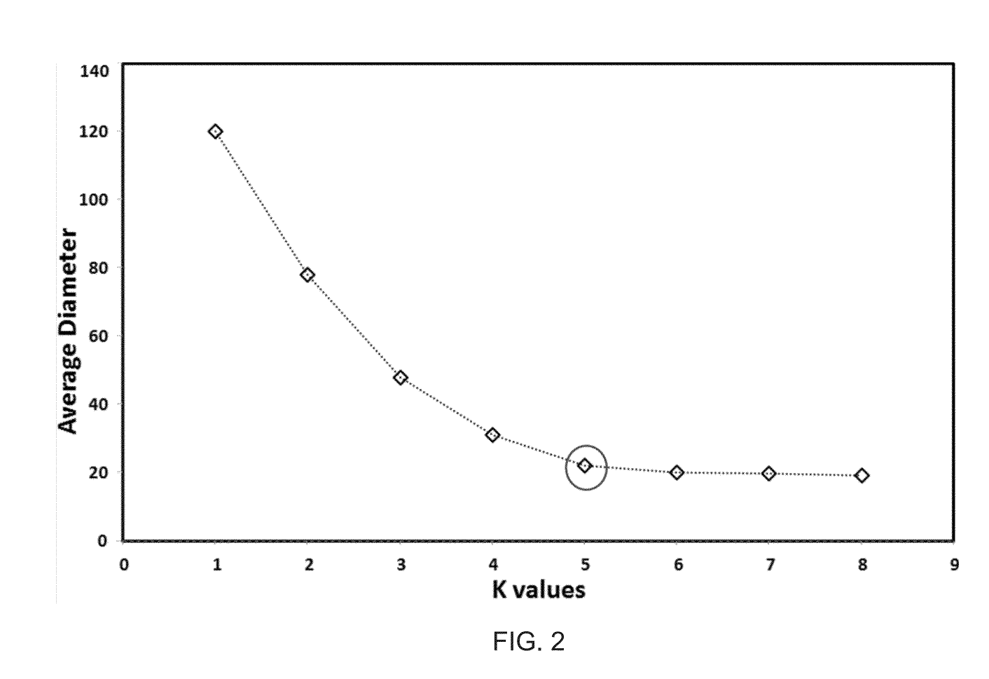

For example, FIG. 2 shows a distortion curve for input data by running a standard k-means for all values of k between 1 and 8. The parallel iteration step one computes for k=1, 2, 4, 8; the parallel iteration step two computes for k=5, 6, 7. Finally, k=5 is selected as the “elbow” point.

C. Parallel Algorithm

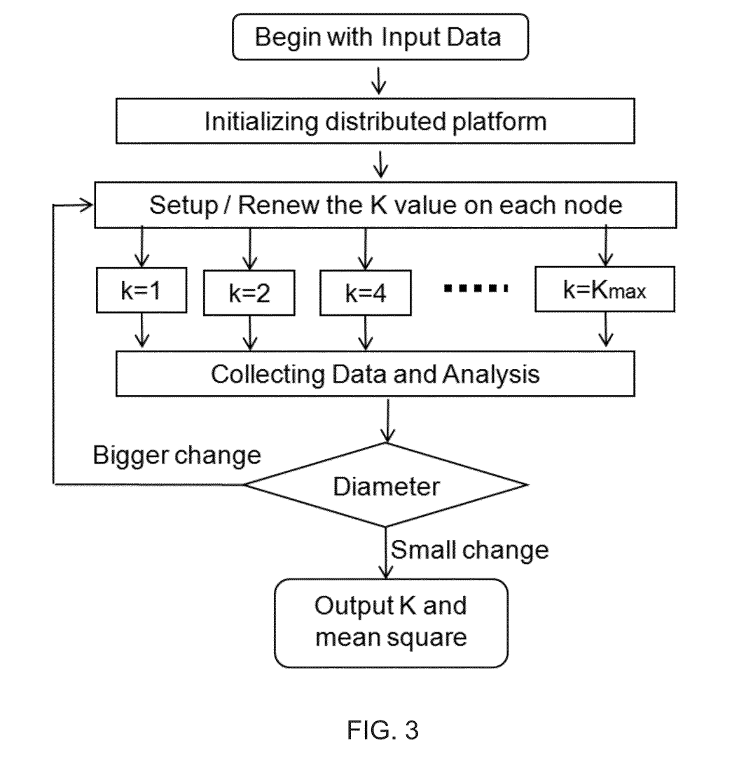

FIG. 3 illustrates a parallel algorithm to implement the k search and k-means clustering according to this disclosure. As shown in FIG. 3, a distributed platform having multiple computing nodes (i.e., machines, computers, processing units, etc.) is initialized, and then k values are assigned to different nodes. The nodes compute for each k value in parallel. Then a data analysis node collects and examines the output, and plots a distortion curve for analysis. The data analysis node may be one of the computing nodes or may be a separate node.

If a distributed platform has M nodes, in total 2 log₂ Kₘₐₓ+1 times of computation and search operations are mapped on the M nodes. If M is less than 2 log₂ Kₘₐₓ+1, two steps of computing are needed: first, spend (2 log₂ Kₘₐₓ+1)/M iterations in step one for finding the range; next, spend (log₂ Kₘₐₓ)/M iterations to narrow down the k value to a specific point. In the parallel process, the calculation of k-means can be highly parallelized by distributing the test points to the distributed machines that can narrow the search ranges; this improves the speed for finding the target points.

D. Distributed Platform

In embodiments of this disclosure, software such as GraphLab (described in REF6) can be used as a tool to implement the parallel k-means computing. GraphLab is a high-level graph-parallel abstraction that efficiently and intuitively expresses computational dependencies. Computation in GraphLab can be applied to dependent records that are stored as vertices in a large distributed data-graph. Computation in GraphLab is expressed as one or more vertex-programs, which are executed in parallel on each vertex and can interact with neighboring vertices. In contrast to the more general message passing and actor models, GraphLab constrains the interaction of vertex-programs to the graph structure enabling a wide range of system optimizations. While embodiments of this disclosure are described as being implemented with GraphLab, it will be understood that other suitable software or tools may additionally or alternatively be used.

In an embodiment, an iterative method of determining a k value in k-means clustering includes the following steps. First, a k-means algorithm is performed for each number k of a set of numbers in a range of 1 to Kₘₐₓ for a space of data to determine a plurality of cluster centers. Each k-means algorithm performed in parallel by one of a plurality of nodes in a parallel computing platform. After that, a distortion curve is generated from the results of performing the k-means algorithms. After one or more iterations of the performing and generating steps, an updated number k of clusters of the space of the data are identified, based on the distortion curve.

The method may also include the following steps. After a first iteration of the performing and generating steps, a plurality of cluster center points calculated in the first iteration are inherited. The cluster center points are used as initially selected points for a second iteration. After that, the second iteration of the k-means algorithm based on the initially selected points is performed, and a second distortion curve is generated from the results of performing the second iteration of the k-means algorithms. An updated number k of clusters of the space of the data is identified, based on the second distortion curve.

The method may also or alternatively include the following steps. After a first iteration of the performing and generating steps, one or more cluster center points calculated in the first iteration are removed from use in a second iteration, according to testing needs. The second iteration of the k-means algorithm is performed based on the initially selected points. A second distortion curve is generated from the results of performing the second iteration of the k-means algorithms. An updated number k of clusters of the space of the data is identified, based on the second distortion curve. The one or more removed cluster center points have a minimal number of elements. The number of removed cluster center points is determined based on a target number of k of a local iteration of computation. The second iteration uses remaining center points not removed after the first iteration, as initially selected points.

The method may also or alternatively include the following steps. After a first iteration of the performing and generating steps, one or more cluster center points calculated in the first iteration are combined for use in a second iteration, according to the testing needs. The second iteration of the k-means algorithm is performed based on the initially selected points. A second distortion curve is generated from the results of performing the second iteration of the k-means algorithms. An updated number k of clusters of the space of the data is identified, based on the second distortion curve. The cluster center points that are combined have a minimal number of elements after combination compared with combining other center points. The second iteration uses the combined center points from the first iteration, as initially selected points.

III. Selection of Initial Centroids in Parallel Algorithm

In addition to parallel acceleration, the performance for k-means clustering on each value of k also depends on the selection of initial cluster centers and the value of k. In general, multiple iterations of parallel computing are used, as the number of parallel machines is less than the number of test points k. When two or more parallel iterations of testing are performed, the selection of the initial cluster centers in the next iteration can utilize the information from the previous computing results. Compared to initializing from random points as the cluster centers, this method can significantly reduce the number of iterations to complete the k-means clustering that follows. The following embodiments provide two methods to utilize the cluster centers in the previous clustering results.

A. Merging Centroids

Let k_{old} represent the number of centroids resulting from the clustering of value k=k_{old}. Let k_{new} represent the current k value. One method to obtain k_{new} centroids from the k_{old} existing centroids of the previous iteration is to merge k′=k_{old}−k_{new}+1 selected centroids.

In the selection of the k′ centroids to be merged, it is important to minimize the result without increasing errors to the system. The increasing errors can be related to (1) the distances between the centers of the new cluster and the merged clusters, and (2) the number of the objectives in each merged cluster. This can be proven as follows.

Let S₁, S₂, . . . , S_{k′} represent the clusters to be merged. S_{new} is the new formed cluster, i.e., S_{new}=S₁ ∪ . . . ∪ S_{k′}. The center of cluster Sᵢ is represented as Cᵢ⁽¹⁾, the element e of cluster Sᵢ is Sᵢ(e), and the number of objectives in cluster Sᵢ is represented as nᵢ. The new center of cluster S_{new} is C_{new}⁽⁰⁾. For any objective a and b, d(a,b) represents the distance between a and b. Thus the computation for the increasing error to the system is:

$${\sum }_{i = 1}^{{k}^{′}} {\sum }_{e = 1}^{{n}_{i}} {d}^{2} ( {C}_{new}^{( 0 )} , {S}_{i} ( e ) ) - {\sum }_{i = 1}^{{k}^{′}} {\sum }_{e = 1}^{{n}_{i}} {d}^{2} ( {C}_{i}^{( 0 )} , {S}_{i} ( e ) ) = {\sum }_{i = 1}^{{k}^{′}} {\sum }_{e = 1}^{{n}_{i}} ( {\vert {( {C}_{new}^{( 0 )} )}_{x} - {( {S}_{i} ( e ) )}_{x} \vert}^{2} + ( {\vert {( {C}_{new}^{( 0 )} )}_{y} - {( {S}_{i} ( e ) )}_{y} \vert}^{2} ) - {\sum }_{i = 1}^{{k}^{′}} {\sum }_{e = 1}^{{n}_{i}} ( {\vert {( {C}_{i}^{( 0 )} )}_{x} - {( {S}_{i} ( e ) )}_{x} \vert}^{2} + ( {\vert {( {C}_{i}^{( 0 )} )}_{y} - {( {S}_{i} ( e ) )}_{y} \vert}^{2} ) = {\sum }_{i = 1}^{{k}^{′}} {n}_{i} {d}^{2} ( {C}_{i}^{( 0 )} , {C}_{new}^{( 0 )} ) ) \qquad ( 3 )$$

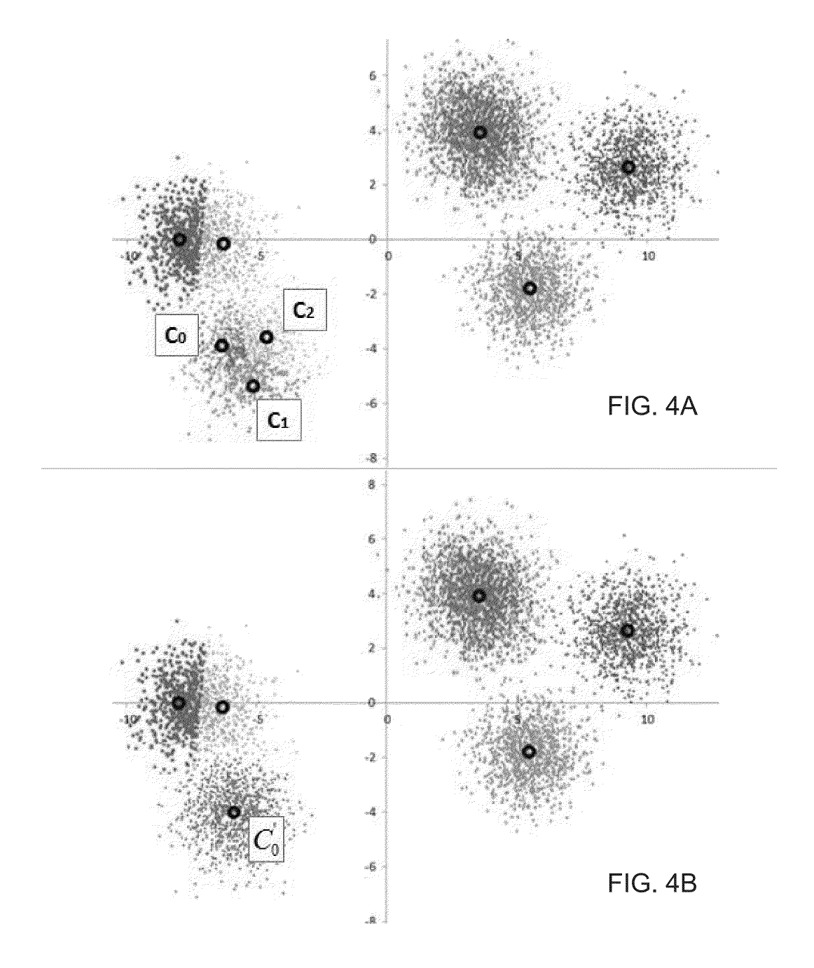

The merging process is demonstrated in FIGS. 4A and 4B. FIG. 4A illustrates an example with five synthetic clusters with eight centroids (k=8). Three of the centroids are labeled C₀, C₁, and C₂. In FIG. 4B, the three centroids C₀, C₁, and C₂ are merged into a single centroid C′₀, thus leaving six centroids overall (k=6).

The algorithm for k searching is as follows:

1) For k_{old} existing clusters whose centers are located at C₁⁽⁰⁾, C₂⁽⁰⁾, . . . , C_{kold}⁽⁰⁾, k_{new} is the number of new clusters to be produced;

2) There are k′=k_{old}−k_{new}+1 centroids that are to be merged among all centroids;

3) Use the formula in equation (3) to merge the centroids, until there are k_{new} centroids left;

4) Start k-means computing on k_{new} initial cluster centers C₁⁽⁰⁾, C₂⁽⁰⁾, . . . , C_{knew}⁽⁰⁾, until the algorithm converges and the procedure is terminated.

In the centroids merging stage, this approach does not change any of the centroids other than those to be merged. As shown in the formula, the complexity to find and merge k′ centroids uses Cₖ^{k}′ rounds of computing. The time used for each round of merging operation is k′/k times of normal k-means iteration. If the cost of merging centroids is less than the time saving of the k-means clustering, it will accelerate the speed of k-means clustering. This approach is especially useful in step 2, where most of the cases k′=1, it can significantly reduce the computing process of k-means clustering.

B. Keep Centroids that have Most Objectives

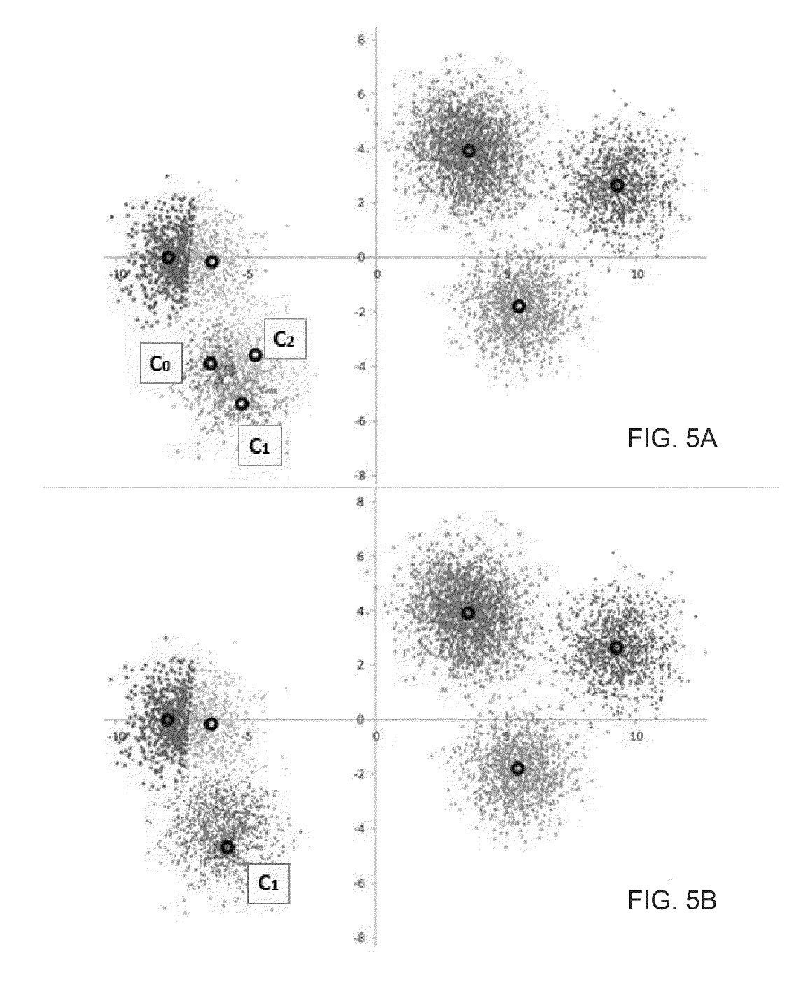

The second method is to simply remove k′=k_{old}−k_{new} centroids belonging to the selected clusters that have a smaller number of objectives within. This operation uses only the number of objectives in the clusters inherent from the previous round of computing, thus it incurs a minimum cost on centroid selections. This removal process is demonstrated in FIGS. 5A and 5B. FIG. 5A illustrates an example with five synthetic clusters with eight centroids (k=8). Three of the centroids are labeled C₀, C₁, and C₂. In FIG. 5B, two centroids that have a fewer number of objects (C₀ and C₂) are removed, thus leaving six centroids overall (k=6).

The algorithm for k searching is as follows:

1) For k_{old} existing clusters whose centers are located at C₁⁽⁰⁾, C₂⁽⁰⁾, . . . , C_{kold}⁽⁰⁾, k_{new} is the number of new clusters to be produced;

2) There are k′=k_{old}−k_{new} centroids that are to be removed;

3) Let Nᵢ represent the number of elements in Sᵢ, where i ∈ [1,k_{old}], and find the first to k^{th} smallest and remove the corresponding centroids Sᵢ⁽¹⁾;

4) Start k-means computing on k_{new} initial cluster centers C₁⁽⁰⁾, C₂⁽⁰⁾, . . . , C_{knew}⁽⁰⁾, until the algorithm converges and the procedure is terminated.

Compared with the merging centroids method described in Section A above, in this method, k′ centroids whose cluster has the minimum number of objects are simply removed. There is no cost for distinguishing which centroids are to be removed, because the number of objects of each centroid is already known in the k=k_{old} iteration of computing. This ensures that the improvement in processing time is always positive.

As described above, the number of test points at step 1 is log₂ Kₘₐₓ+1, and the number of test points at step 2 is log₂ Kₘₐₓ. On a total of M parallel machines, (log₂ Kₘₐₓ+1)/M and log₂ Kₘₐₓ/M iterations are needed for the first step and the second step, respectively. Thus in total, [(log₂ Kₘₐₓ+1)/M]+[log₂ Kₘₐₓ/M] rounds of computing is needed. The theoretical parallel increase in speed is given by:

$$\frac{2 log {k}_{ma x} + 1}{[ ( {log}_{2} {k}_{ma x} + 1 ) / m ] + [ log {k}_{ma x} / m ]} . \qquad ( 4 )$$

The additional increase in speed by optimizing the centroids in k-means computing depends on the shape and scale of the distribution of points in a data set and the desired clustering resolution of the user, where the first method described above (Merging Centroids) provides the best increase in speed when k′=1; and the second method (Keep Centroids That Have Most Objectives) can always be positive to reduce the clustering iterations.

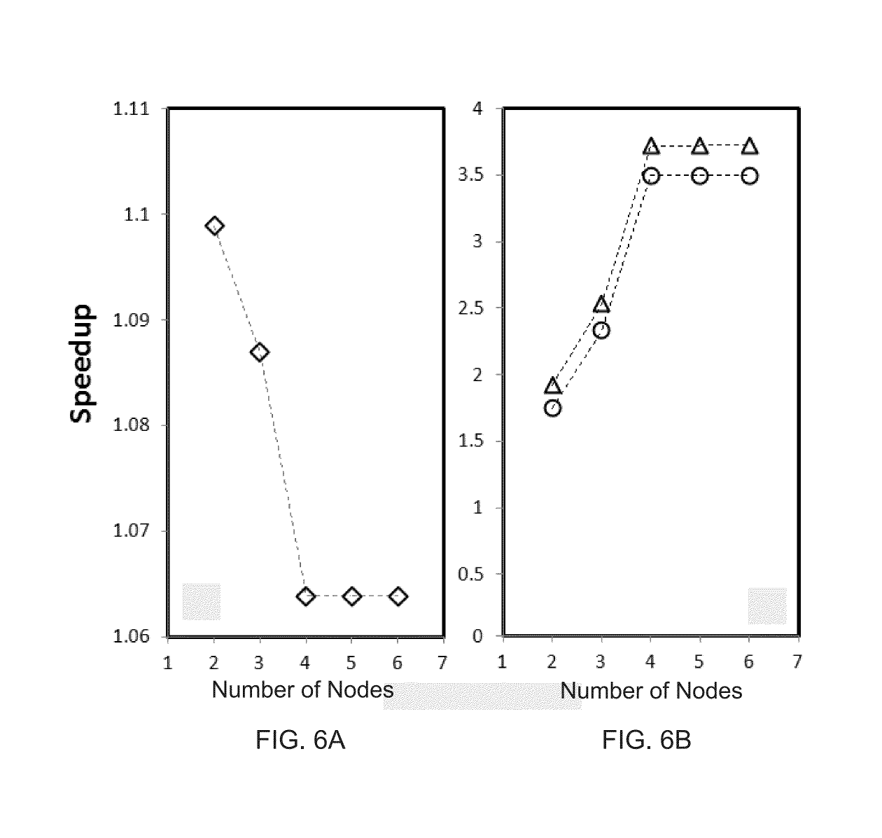

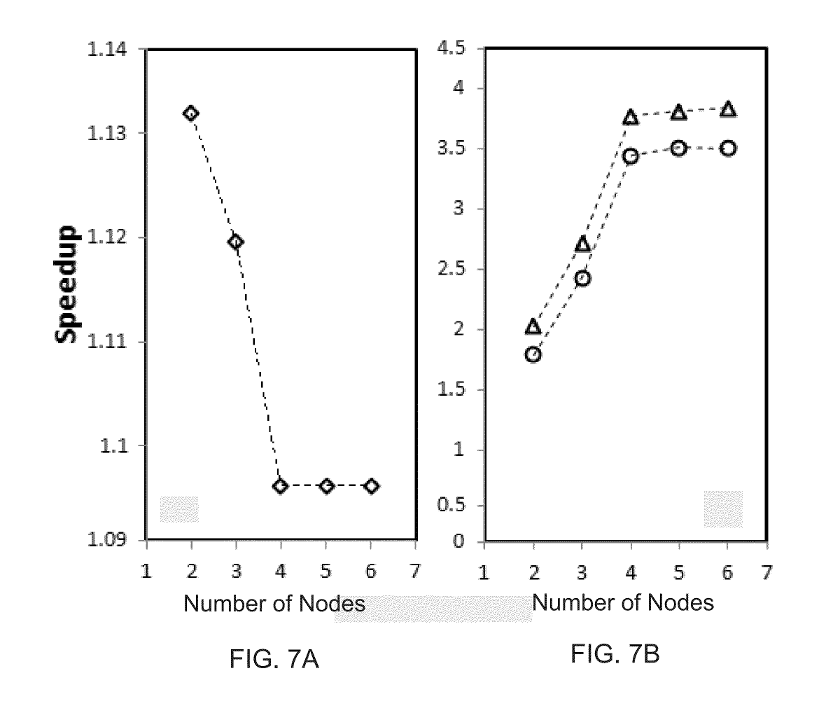

The performance improvement of the aforementioned embodiments has been validated using five clusters of synthetic data, containing approximately 100,000 two-dimensional objects, as shown in FIGS. 6A and 6B. Two-dimensional data are chosen for the demonstration because it is easier to plot in a figure. The performance for higher dimensional data sets have also been examined and validated. For example, FIGS. 7A and 7B shows the performance of 50,000 ten-dimensional objects.

In some embodiments, GraphLab is used to implement the algorithm. The programs are tested on three distributed machines working in parallel, each machine having twenty-four cores. The first iteration of computing has three values of k (i.e., k=1, 2, 4) to be computed on each machine in parallel. The second iteration computes k=8, 16, 32. After this iteration, the k is determined to be located inside the range of [4, 8] by analyzing the distortion curve. Next, the third iteration computes k-means clustering k=5, 6, 7; k=5 is finally chosen as the real k value in the data set.

The parallel speed increases are shown in FIG. 6B for 100,000 two-dimensional objects, and FIG. 7B for 50,000 ten-dimensional objects, respectively. The lower curve is a speed increase from distributing k values to compute on parallel machines. The upper curve is the parallel algorithm executing with optimized centroid initialization. When the number of parallel machines increases from four to six, no obvious speed increases are observed because the total number k of searching steps is the same.

FIG. 6A and FIG. 7A show the speed increase by optimizing initial centroids for the two data sets, as compared to computing with non-optimized execution starting from random selected centers. On the two-dimensional data sets, an average speed increase of 12% has been observed; where on the ten-dimensional data sets, in average, a 14% speed increase is obtained. This suggests that in some embodiments, the optimization of centroids approach offers better performance improvement for higher dimensional data sets.

The embodiments described above provide a parallel algorithm to implement k searching and k-means computing. Two initial centroid selection methods have been introduced that can improve performance for further computing. More specifically, the disclosed embodiments can significantly improve the computing speed of k-means searching and computing.

The methods described above can be implemented on any suitably arranged electronic computing device or system of computing devices. Example embodiments of such computing devices include: desktop computers, server computers, mobile terminals, network communication systems, and so on. Electronic computing devices implementing the steps and methods above can receive, display, and transmit data related to any step described. Below, a computing device is described that implements the methods discussed above.

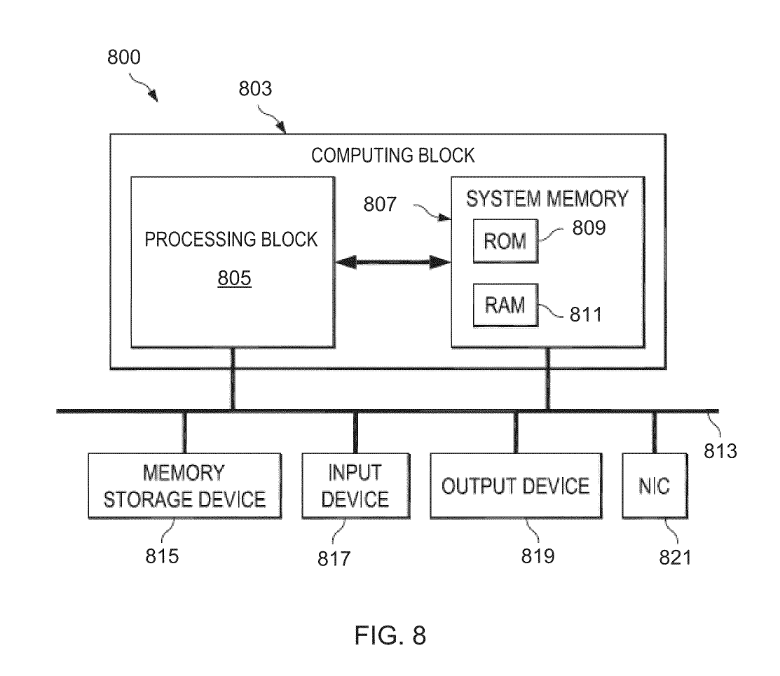

FIG. 8 illustrates an example of a computing device 800 for performing all or a portion of any of the methods for iteratively determining a k value in k-means clustering. In general, the methods disclosed herein are performed using a parallel computing platform comprising a plurality of computing nodes, such as a data center that includes multiple servers connected by a network. Each computing node may be represented by one computing device 800. The parallel computing platform may have as few or as many computing nodes (e.g., computing devices 800) as needed to perform the disclosed methods.

As shown in FIG. 8, the computing device 800 includes a computing block 803 with a processing block 805 and a system memory 807. The processing block 805 may be any type of programmable electronic device for executing software instructions, but will conventionally be one or more microprocessors. The system memory 807 may include both a read-only memory (ROM) 809 and a random access memory (RAM) 811. As will be appreciated by those of skill in the art, both the read-only memory 809 and the random access memory 811 may store software instructions for execution by the processing block 805.

The processing block 805 and the system memory 807 are connected, either directly or indirectly, through a bus 813 or alternate communication structure, to one or more peripheral devices. For example, the processing block 805 or the system memory 807 may be directly or indirectly connected to one or more additional memory storage devices 815. The memory storage devices 815 may include, for example, a “hard” magnetic disk drive, a solid state disk drive, an optical disk drive, and a removable disk drive. The processing block 805 and the system memory 807 also may be directly or indirectly connected to one or more input devices 817 and one or more output devices 819. The input devices 817 may include, for example, a keyboard, a pointing device (such as a mouse, touchpad, stylus, trackball, or joystick), a touch screen, a scanner, a camera, and a microphone. The output devices 819 may include, for example, a display device, a printer and speakers. Such a display device may be configured to display video images. With various examples of the computing device 800, one or more of the peripheral devices 815-819 may be internally housed with the computing block 803. Alternately, one or more of the peripheral devices 815-819 may be external to the housing for the computing block 803 and connected to the bus 813 through, for example, a Universal Serial Bus (USB) connection or a digital visual interface (DVI) connection.

With some implementations, the computing block 803 may also be directly or indirectly connected to one or more network interfaces cards (NIC) 821, for communicating with other devices making up a network. The network interface cards 821 translate data and control signals from the computing block 803 into network messages according to one or more communication protocols, such as the transmission control protocol (TCP) and the Internet protocol (IP). Also, the network interface cards 821 may employ any suitable connection agent (or combination of agents) for connecting to a network, including, for example, a wireless transceiver, a modem, or an Ethernet connection.

It should be appreciated that the computing device 800 is illustrated as an example only, and it not intended to be limiting. Various embodiments of this disclosure may be implemented using one or more computing devices that include the components of the computing device 800 illustrated in FIG. 8, or which include an alternate combination of components, including components that are not shown in FIG. 8. For example, various embodiments of the invention may be implemented using a multi-processor computer, a plurality of single and/or multiprocessor computers arranged into a network, or some combination of both.

In some embodiments, some or all of the functions or processes of the one or more of the devices are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory.

It may be advantageous to set forth definitions of certain words and phrases used throughout this patent document. The terms “include” and “comprise,” as well as derivatives thereof, mean inclusion without limitation. The term “or” is inclusive, meaning and/or. The phrases “associated with” and “associated therewith,” as well as derivatives thereof, mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An iterative method for determining a k value in k-means clustering, the method comprising:
performing a k-means algorithm for each number k of a set of numbers in a range of 1 to Kₘₐₓ for a space of data to determine a plurality of cluster centers, each k-means algorithm performed in parallel by one of a plurality of nodes in a parallel computing platform;
generating a distortion curve from the results of performing the k-means algorithms; and
identifying, after one or more iterations of the performing and generating steps, an updated number k of clusters of the space of the data, based on the distortion curve.

2. The method of claim 1, further comprising:
after a first iteration of the performing and generating steps, inheriting a plurality of cluster center points calculated in the first iteration, and using the cluster center points as initially selected points for a second iteration;
performing the second iteration of the k-means algorithm based on the initially selected points;
generating a second distortion curve from the results of performing the second iteration of the k-means algorithms; and
identifying an updated number k of clusters of the space of the data, based on the second distortion curve.

3. The method of claim 1, further comprising:
after a first iteration of the performing and generating steps, removing one or more cluster center points calculated in the first iteration from use in a second iteration, according to testing needs;
performing the second iteration of the k-means algorithm based on the initially selected points;
generating a second distortion curve from the results of performing the second iteration of the k-means algorithms; and
identifying an updated number k of clusters of the space of the data, based on the second distortion curve, wherein:
the one or more removed cluster center points have a minimal number of elements,
the number of removed cluster center points is determined based on a target number of k of a local iteration of computation, and
the second iteration uses remaining center points not removed after the first iteration, as initially selected points.

4. The method of claim 1, further comprising:
after a first iteration of the performing and generating steps, combining one or more cluster center points calculated in the first iteration for use in a second iteration, according to the testing needs;
performing the second iteration of the k-means algorithm based on the initially selected points;
generating a second distortion curve from the results of performing the second iteration of the k-means algorithms; and
identifying an updated number k of clusters of the space of the data, based on the second distortion curve, wherein:
the cluster center points that are combined have a minimal number of elements after combination compared with combining other center points, and
the second iteration uses the combined center points from the first iteration, as initially selected points.

5. A method comprising:
performing a k-means algorithm for each number k of a set of numbers in a range of 1 to Kₘₐₓ for a space of data to determine a plurality of cluster centers, each k-means algorithm performed in parallel by one of a plurality of nodes;
generating a distortion curve from the results of performing the k-means algorithms; and
identifying, after one or more iterations of the performing and generating steps, a number of clusters of the space of the data based on the distortion curve.

6. The method of claim 5, further comprising:
selecting two or more cluster centers of the plurality of cluster centers determined by a first iteration of the k-means algorithms;
merging the two or more cluster centers within the plurality of cluster centers, the plurality of cluster centers used by a second iteration of the k-means algorithms.

7. The method of claim 5, further comprising:
selecting one or more cluster centers of the plurality of cluster centers determined by a first iteration of the k-means algorithms;
removing the one or more cluster centers from the plurality of cluster centers, the plurality of cluster centers used by a second iteration of the k-means algorithms.

8. A system comprising:
a plurality of first nodes configured to perform a plurality of k-means algorithms in parallel to determine a plurality of cluster centers, the plurality of k-means algorithms comprising a set of algorithms corresponding to each number k of a set of numbers in a range of 1 to Kₘₐₓ for a space of data, each first node configured to perform at least one of the k-means algorithms; and
a second node configured to:
generate a distortion curve from the results of the first nodes performing the k-means algorithms; and
identify, after one or more iterations of the performing and generating steps, a number of clusters of the space of the data based on the distortion curve.

9. The system of claim 8, wherein the second node is further configured to:
select two or more cluster centers of the plurality of cluster centers determined by a first iteration of the k-means algorithms performed by the first nodes;
merge the two or more cluster centers within the plurality of cluster centers, the plurality of cluster centers used by the first nodes to perform a second iteration of the k-means algorithms.

10. The system of claim 8, wherein the second node is further configured to:
select one or more cluster centers of the plurality of cluster centers determined by a first iteration of the k-means algorithms performed by the first nodes;
remove the one or more cluster centers from the plurality of cluster centers, the plurality of cluster centers used by the first nodes to perform a second iteration of the k-means algorithms.
